(19) United States
(12) Patent Application Publication
(10) Pub. No.: US 2021/0076862 A1
(43) Pub. Date: Mar. 18, 2021

(54) REFRIGERATOR APPLIANCE WITH COOKING FEATURES

(71) Applicant: Haier US Appliance Solutions, Inc., Wilmington, DE (US)

(72) Inventors: William Everette Gardner, Louisville, KY (US); Matthew Hunter, Louisville, KY (US); Brent Alden Junge, Evansville, KY (US)

(21) Appl. No.: 16/572,706

(22) Filed: Sep. 17, 2019

(51) Int. Cl. A47J 27/10; A23L 5/10; F25D 25/02; F25D 11/02; A47J 27/00

(52) U.S. Cl. CPC A47J 27/10; A23L 5/13; F25D 2400/02; F25D 11/02; A47J 27/004; F25D 25/025

(57) ABSTRACT

A refrigerator appliance includes a cabinet that defines a chilled chamber. A drawer is slidably mounted within the chilled chamber and slides between an open position and a closed position. The refrigerator appliance also includes a heating unit disposed in a stationary position within the cabinet. The heating unit is proximate the drawer when the drawer is in the closed position. As such, the heating unit is in operative communication with the drawer when the drawer is in the closed position whereby the heating unit provides heat to the drawer within the chilled chamber when the drawer is in the closed position and the heating unit is activated.

### FIELD OF THE INVENTION

The present disclosure relates generally to refrigerator appliances. In particular, the present disclosure relates to refrigerator appliances which not only provide features for chilled storage of food items but also provide features for selectively heating, e.g., cooking, such food items.

### BACKGROUND OF THE INVENTION

Refrigerator appliances generally include a cabinet that defines chilled chambers for receipt of food items for storage. Typically, such appliances only include features for chilling and storing of food and do not include features for heating or cooking the food. Generally, a separate appliance such as a range oven or a microwave oven is required in order to cook food. Thus, a user of the refrigerator appliance must manually remove one or more food items from the refrigerator appliance, prepare the food item(s), and place the food item(s) in the separate appliance in order to ultimately enjoy a prepared meal.

Accordingly, a refrigerator appliance with features for not only storing but also cooking one or more food items therein would be useful.

### BRIEF DESCRIPTION OF THE INVENTION

Aspects and advantages of the invention will be set forth in part in the following description, or may be apparent from the description, or may be learned through practice of the invention.

In an exemplary embodiment, a refrigerator appliance is provided. The refrigerator appliance defines a vertical direction, a lateral direction and a transverse direction. The vertical, lateral and transverse directions are mutually perpendicular. The refrigerator appliance also includes a cabinet that extends from a top to a bottom along the vertical direction. The cabinet also extends from a left side to a right side along the lateral direction and along the transverse direction from a front end to a back end. The cabinet defines a chilled chamber. A drawer is slidably mounted within the chilled chamber such that the drawer is disposed within the chilled chamber when the drawer is in a closed position and is at least partially disposed outside the chilled chamber when the drawer is in an open position. The closed position and the open position are separated from each other along the transverse direction. The drawer includes a drawer body defining an interior of the drawer and a door attached to the drawer body. A cooling system is disposed in a mechanical compartment of the refrigerator appliance. The cooling system is in fluid communication with the chilled chamber to provide a flow of chilled air to the chilled chamber. The refrigerator appliance also includes a heating unit disposed in a stationary position within the cabinet. The heating unit is proximate the drawer when the drawer is in the closed position. As such, the heating unit is in operative communication with the drawer when the drawer is in the closed position whereby the heating unit provides heat to the drawer within the chilled chamber when the drawer is in the closed position and the heating unit is activated.

In another exemplary embodiment, a refrigerator appliance is provided. The refrigerator appliance includes a cabinet. The cabinet defines a chilled chamber. A drawer is slidably mounted within the chilled chamber such that the drawer is disposed within the chilled chamber when the drawer is in a closed position and is at least partially disposed outside the chilled chamber when the drawer is in an open position. The drawer includes a drawer body defining an interior of the drawer and a door attached to the drawer body. A cooling system is disposed in a mechanical compartment of the refrigerator appliance. The cooling system is in fluid communication with the chilled chamber to provide a flow of chilled air to the chilled chamber. The refrigerator appliance also includes a heating unit disposed in a stationary position within the cabinet. The heating unit is proximate the drawer when the drawer is in the closed position. As such, the heating unit is in operative communication with the drawer when the drawer is in the closed position whereby the heating unit provides heat to the drawer within the chilled chamber when the drawer is in the closed position and the heating unit is activated.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary refrigerator appliance according to one or more embodiments of the present subject matter.

FIG. 2 provides a perspective view of the refrigerator appliance of FIG. 1 with a drawer in an open position.

FIG. 3 provides a section view of the refrigerator appliance of FIG. 1.

FIG. 4 provides a perspective view of an exemplary drawer as may be used with the refrigerator appliance of FIG. 1.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. Terms such as “inner” and “outer” refer to relative directions with respect to the interior and exterior of the refrigerator appliance, and in particular the food storage chamber(s) defined therein. For example, “inner” or “inward” refers to the direction towards the interior of the refrigerator appliance. Terms such as “left,” “right,” “front,” “back,” “top,” or “bottom” are used with reference to the perspective of a user accessing the refrigerator appliance. For example, a user stands in front of the refrigerator to open the doors and reaches into the food storage chamber(s) to access items therein.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

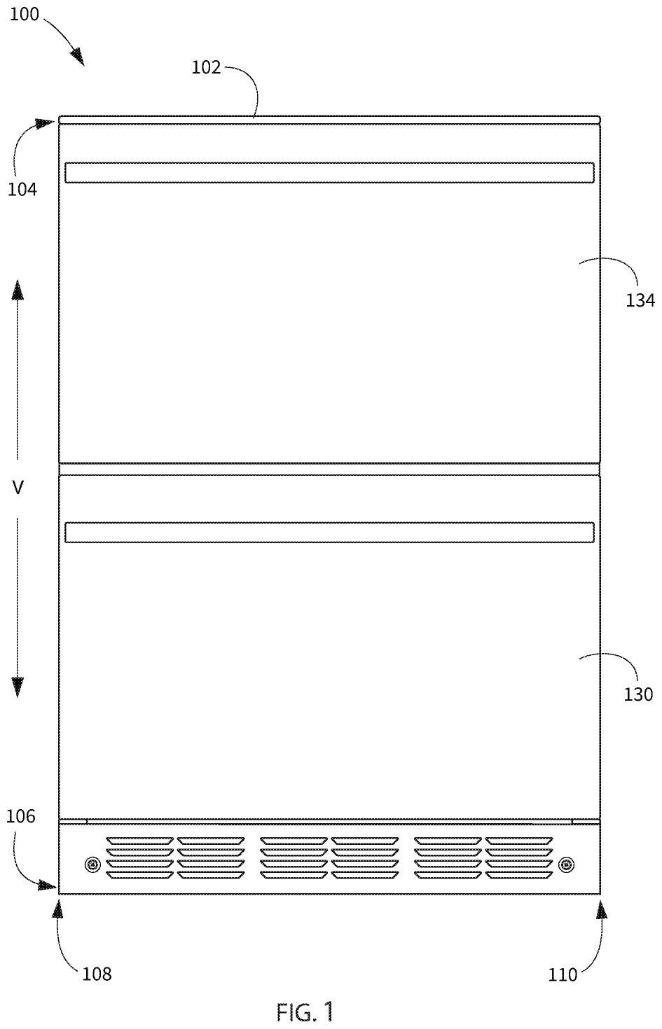

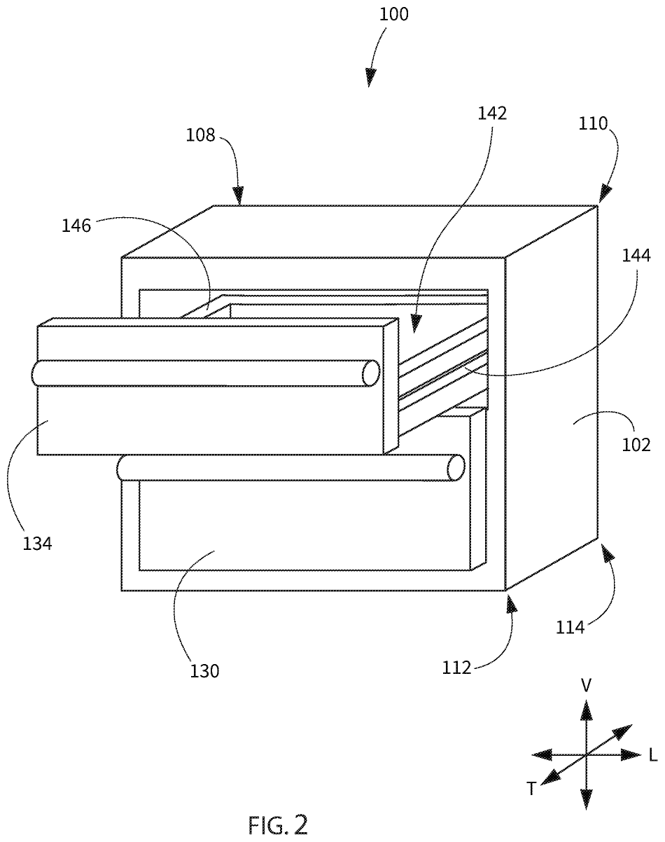

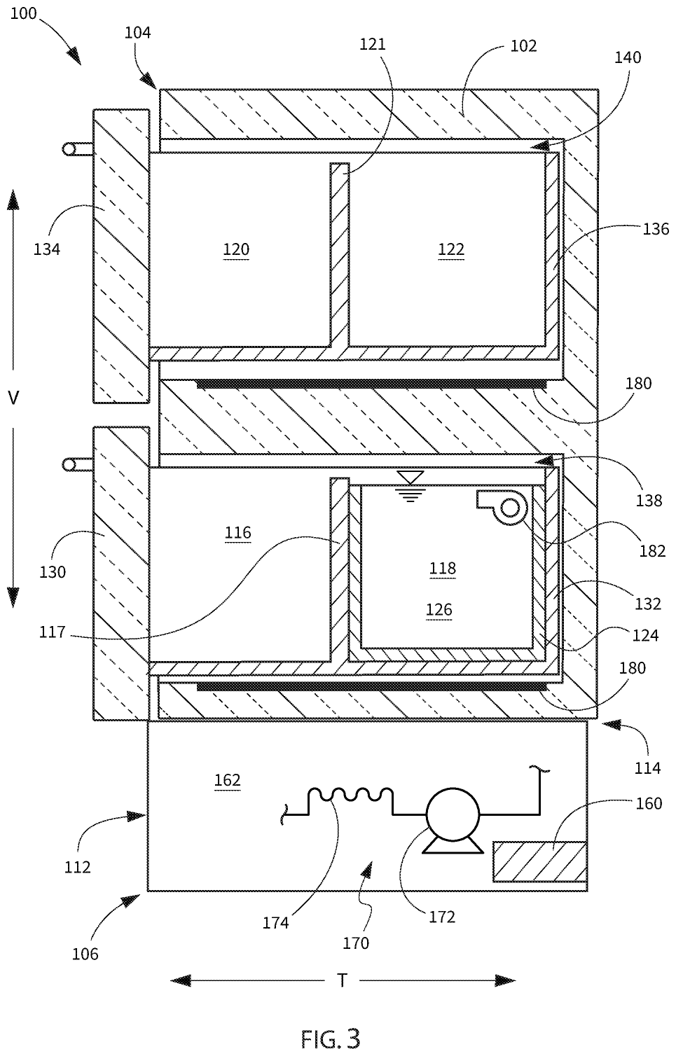

FIG. 1 provides a front view of an exemplary refrigerator appliance 100 according to one or more embodiments of the present subject matter. FIG. 2 is a perspective view of the refrigerator appliance 100 having a drawer 136 in an open position to reveal the interior 142 of the drawer 136. FIG. 3 provides a section view of the refrigerator appliance of FIG. 1. The example refrigerator appliance 100 depicted and described herein is generally referred to as a double-drawer refrigerator appliance. In various embodiments, the refrigerator appliance 100 may be configured as a freestanding unit, or, in other embodiments, the refrigerator appliance 100 may be configured as an under counter unit for mounting or installation within or adjacent to cabinetry underneath a counter, such as a kitchen counter. For example, in embodiments where the refrigerator appliance 100 is configured as a freestanding unit, a decorative outer skin may be provided which forms an outermost surface of the appliance, e.g., the outer skin may be stainless steel. In further example embodiments, the refrigerator appliance 100 may include only a single drawer and may be configured as a countertop unit. Generally, the drawer or drawers are the only storage compartments provided in the refrigerator appliance 100, providing a relatively compact overall package for the appliance, as compared to, e.g., a full-sized refrigerator appliance, such as may also include a freezer compartment or chamber, for example.

Refrigerator appliance 100 defines a vertical direction V, a lateral direction L, and a transverse direction T, each mutually perpendicular to one another. As may be seen in FIGS. 1 through 3, refrigerator appliance 100 includes a cabinet or housing 102 that extends between a top 104 and a bottom 106 along a vertical direction V, between a left side 108 and a right side 110 along the lateral direction L, and between a front end 112 and a back end 114 along the transverse direction T. Housing 102 defines at least one chilled chamber 138 (FIG. 3) for receipt of food items for storage. In some embodiments, the refrigerator appliance 100 may include more than one chilled chambers, e.g., the refrigerator appliance 100 may include first chilled chamber 138 and at least a second chilled chamber 140, as illustrated in FIG. 3. As used herein, the chamber(s) may be “chilled” in that the or each chamber is operable at temperatures below room temperature, e.g., less than about seventy-five degrees Fahrenheit (75° F.).

A door 130 may be coupled to a drawer 132 slidably mounted within chilled chamber 138. In embodiments where the second chilled chamber 140 is provided, a second drawer 136 with a second door 134 coupled thereto may be slidably mounted in the second chilled chamber 140. Additionally, one or more gaskets and other sealing devices, which are not shown but will be understood by one of ordinary skill in the art, may be provided to promote sealing between the doors 130 and 134 and the cabinet 102.

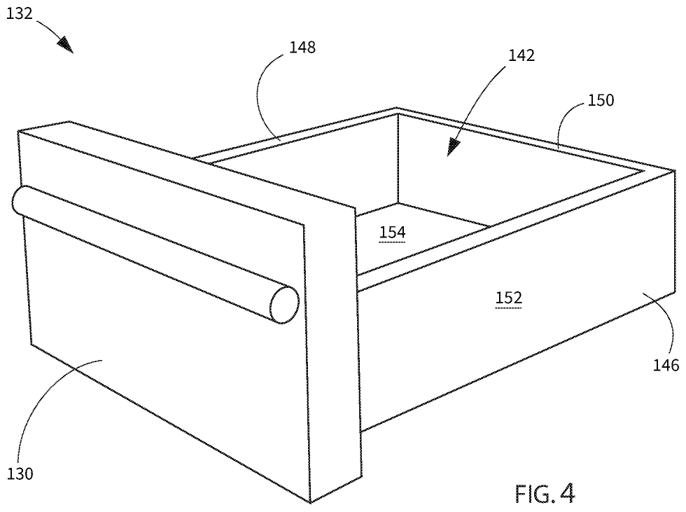

As best seen in FIGS. 2 and 4, the drawer(s) 132 and/or 136 may include a drawer body 146 which includes a left wall 148, a back wall 150, a right wall 152, and a floor 154. It should be understood that in embodiments where the first drawer 132 and the second drawer 136 are both provided, the drawers 132 and 136 may each include the left wall 148, the back wall 150, the right wall 152, and the floor 154, where repeat reference numbers are used to identify the same or similar (e.g., duplicate) parts of the drawers 132 and 136. The drawer body 146 at least partially defines an interior 142 of the drawer 132 or 136 which may provide a storage volume, e.g., for food items. In some embodiments, the drawer(s) 132 and/or 136 may be slidably mounted within the cabinet 102 by a left slide 144 on the left side wall 148 and a right slide 144 on the right side wall 152, such that the drawer(s) 132 and/or 136 can slide along the transverse direction T between the closed position (FIG. 1) and the open position (FIG. 2). To promote accessibility of such food items which may be stored within the interior 142 of the drawer(s) 132 and/or 136, the drawer(s) 132 and/or 136 may be at least partially disposed outside the respective chilled chamber(s) 138 and/or 140 when the drawer(s) 132 and/or 136 is or are in the open position.

In embodiments where a second chilled chamber 140 is provided, the second chilled chamber 140 may be spaced apart from the first chilled chamber 138 along the vertical direction V. The first chilled chamber 138 and the second chilled chamber 140 may be vertically arranged within the cabinet 102, e.g., with the first chilled chamber 138 below the second chilled chamber 140. For example, the second chilled chamber 140 may be positioned above the first chilled chamber 138, as illustrated.

Turning now specifically to FIG. 3, a cooling system 170 of the refrigerator appliance 100 is partially schematically illustrated. As shown, the cooling system 170 may be disposed within a mechanical compartment 162 of the refrigerator appliance 100, e.g., in a bottom portion of the cabinet 102 generally at and around the bottom 106 of the cabinet 102. As illustrated, the cooling system 170 may include a compressor 172 and at least one heat exchanger 174. One of ordinary skill in the art will recognize that the cooling system 170 typically includes at least two heat exchangers, including a condenser where a refrigerant releases thermal energy and one or more evaporators where the refrigerant absorbs thermal energy. Thus, the evaporator(s) of the cooling system 170 may produce chilled air (e.g., a flow of air from which the refrigerant has received thermal energy, thereby reducing the temperature of the air) for the chilled chamber(s) 138 and/or 140. For example, in some embodiments, a single evaporator may provide chilled air to both chambers 138 and 140, while in other embodiments each chilled chamber 138 and 140 may have a dedicated evaporator associated therewith. The structure and function of such sealed systems are understood by those of ordinary skill in the art and are not described in further detail herein for the sake of brevity and clarity.

In various embodiments, the chilled chamber(s) 138 and/or 140 may be operable within a temperature range above the freezing point of water and below room temperature, such as between approximately thirty-three degrees Fahrenheit (33° F.) and approximately sixty degrees Fahrenheit (60° F.). For example, an operating temperature of the chilled chamber 138 or 140, e.g., when the cooling system 170 is activated, may be about forty degrees Fahrenheit (40° F.) or about forty-five degrees Fahrenheit (45° F.). In various embodiments, the cabinet 102 may be thermally insulated. The thermal insulation may permit or enhance operation of the chilled chamber(s) 138 and/or 140 at distinct temperatures from the ambient environment, e.g., below room temperature.

Still referring to FIG. 3, one or more heating units 180 may be provided in the refrigerator appliance 100. In contrast to the drawers 132 and 136 which are movably, e.g., slidably, mounted within the cabinet 102, the heating units 180 may be stationary within the cabinet 102. For example, the one or more heating units 180 may be disposed in a stationary position within the cabinet 102. In the example embodiment illustrated in FIG. 3, each heating unit 180 is disposed in a stationary position within the cabinet 102 where the heating unit 180 will be proximate a corresponding one of the drawers 132 and 136 when the corresponding drawer 132 or 136 is in the closed position such that the heating unit 180 is in operative communication with the drawer 132 or 136 when the drawer 132 or 136 is in the closed position whereby the heating unit 180 provides heat to the corresponding drawer 132 or 136 within the chilled chamber 138 or 140 when the drawer 132 or 136 is in the closed position and the corresponding heating unit 180 is activated.

In some embodiments, the or each heating unit 180 may be an induction heating pad operable to provide heat to the drawer 138 or 140 when the drawer 138 or 140 is in the closed position by producing an eddy current in a cooking utensil within the drawer. The structure and function of magnetic induction heating elements and compatible cooking utensils are generally understood by those of ordinary skill in the art and, as such, are not shown or described in greater detail for the sake of brevity and clarity.

In some embodiments, one or both of the drawers 132 and 136 may include a partition in the drawer, and the partition may define a first compartment and a second compartment within the interior of the drawer. For example, as illustrated in FIG. 3, the first drawer 132 may include a partition 117 which divides the interior 142 of the first drawer 132 into a first compartment 116 and a second compartment 118. In some embodiments, such as the example illustrated in FIG. 3, the second drawer 136 may include a partition 121 which divides the interior 142 of the second drawer 136 into a first compartment 120 and a second compartment 122. In particular, the example embodiment illustrated in FIG. 3 includes both a first drawer 132 and a second drawer 136, in such embodiments the partition 117 in the first drawer 132 may be a first partition 117 and the partition 121 in the second drawer 136 may be a second partition 121. Also, in such embodiments, the first and second compartments 120 and 122 of the second drawer 136 may be a third compartment 120 and a fourth compartment 122 of the refrigerator appliance 100. In other embodiments, only one drawer 132 or 136 may be provided, or both drawers 132 and 136 may be provided with only of the drawers 132 and 136 including the partition 117 or 121, among other possible variations and combinations.

Furthermore, the heating units, e.g., induction pads, 180 which are illustrated in FIG. 3 as a single heating unit 180 for each drawer 132 and 135 may instead be provided as multiple heating units per drawer 132 and/or 136, with one heating unit 180 per each compartment 116, 118, 120, and/or 122, in various combinations as described above. Such example embodiments may include a first heating unit 180 and a second heating unit 180, where the first heating unit 180 is proximate the first compartment 116 when the drawer 132 is in the closed position and the second heating unit 180 is proximate the second compartment 118 when the drawer 132 is in the closed position. Further, some embodiments may include a third heating unit 180 proximate the third compartment 120 and a fourth heating unit 180 proximate the fourth compartment 122, e.g., when the second drawer 136 is in the closed position. Thus, the compartments 116, 118, 120, and/or 122 may each be heated to a different level, or one of the drawers 132 and 136 (and/or the compartments therein) may be heated while the other is cooled. As mentioned above and as indicated in FIG. 3, the cabinet 102 may be thermally insulated to promote maintaining a temperature difference between the interior of the cabinet 102 (e.g., the chilled chambers 138 and 140 therein) and an ambient environment. The cabinet 102 may further include thermal insulation between the chambers 138 and 140, whereby a temperature difference between the chambers 138 and 140 (and/or the drawers 132, 136 therein, etc.) may be promoted, for example when one chamber 138 or 140 is operating in a cooling mode or storage mode while the other chamber 138 or 140 is operating in a cooking mode or heating mode.

In some embodiments, a removable tub 124 may be provided. The removable tub 124 may be received within one or both of the drawers 132 and 136, including one or both compartments 116 and 118 or 120 and 122 (or all four, or both compartments in one drawer while the other drawer does not include a partition, etc.). The removable tub 124 may be filled with water for use as a sous vide water bath 126 when heat is provided to the drawer 132 or 136 in which the tub 124 is received from the corresponding heating unit 180. After the sous vide cooking operation is complete, the water bath 126 may be conveniently disposed of, e.g., dumped down a drain, such that the drawer 132 or 136 may then be used again for chilled storage of food items. In some embodiments where the heating unit 180 is an induction pad, the removable tub 124 may comprise a compatible metal for induction heating, such that the removable tub 124 may serve as the cooking utensil in which the eddy current is induced to thereby heat the sous vide water bath 126 and food items therein.

In some embodiments, a circulation pump 182 may be provided in fluid communication with the removable tub 124. The circulation pump 182 may be configured to circulate the water from and within the sous vide water bath 126. For example, in embodiments where the heating units 180 are not induction pads, e.g., resistance heaters, the circulation pump 182 may promote even heating of the water in the sous vide water bath 126.

As mentioned above, in some embodiments, the refrigerator appliance 100 may be a freestanding unit. In such embodiments, where the refrigerator appliance 100 is not anchored or held in place by surrounding fixtures, e.g., a counter and/or cabinetry, a counterweight 160 may be provided to balance the refrigerator appliance 100 when the drawer(s) 132 and/or 136 are in the open position. For example, the counterweight 160 may be provided in or near the mechanical compartment 162. In particular, the counterweight 160 may be provided proximate the back end 114 of the cabinet 102 such that the counterweight 160 is disposed opposite of the extended drawer(s) 132 and/or 136 in the open position with respect to a center of gravity of the refrigerator appliance 100.

Operation of the refrigerator appliance 100 can be regulated by a controller that is operatively coupled to a user interface panel of the refrigerator appliance 100 or a remote user interface device such as a smart phone or computer, etc. The user interface, either on a panel of the appliance 100 or a remote device (or both), provides selections for user manipulation of the operation of refrigerator appliance 100 such as e.g., temperature selections. In response to user manipulation of the user interface, the controller operates various components of the refrigerator appliance 100. The controller may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor.

For example, such operations may include a time-delayed cooking operation. A user may place food items within a selected drawer 132 or 136 or compartment 116, 118, 120, or 122 and may program the refrigerator appliance 100, e.g., via commands input into the controller via the user interface panel or remote user interface device, to chill the food items for a first period of time and to cook the food items after the first period of time has elapsed. For example, a user may place food items to be sous vide cooked in the second compartment 118, with the removable tub 124 and sous vide water bath 126 therein, and may enter a command for delayed cooking. For instance, the food items may be placed in the morning or the previous night and the refrigerator appliance 100 may be programmed to chill the food items for several hours and then to initiate the cooking operation in time for the food items to be ready at an anticipated dinner time. For example, sous vide cooking generally involves temperatures of between about 150° F. and about 200° F., such as about 160° F. or about 180° F. Sous vide cooking also generally involves relatively long cooking times, such as multiple hours, such as between about two hours and about five hours. Thus, referring again to the earlier example, a food item such as chicken may be placed in the refrigerator appliance 100 at seven in the morning (7:00 AM) and the refrigerator appliance 100 may be programmed to store (e.g., chill) the chicken for about seven hours and then cook the chicken for about four hours at about 160° F., such that the chicken will be ready at about six in the evening (6:00 PM). Thus, the refrigerator appliance 100 may activate the cooling system 170 during normal operation, e.g., default condition, of the refrigerator appliance 100 and the refrigerator appliance and/or a controller thereof may deactivate the cooling system 170 and activate the heating unit(s) 180 at a predetermined time based on, e.g., user input.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance defining a vertical direction, a lateral direction and a transverse direction, the vertical, lateral and transverse directions being mutually perpendicular, the refrigerator appliance comprising:
a cabinet extending from a top to a bottom along the vertical direction, the cabinet also extending from a left side to a right side along the lateral direction and along the transverse direction from a front end to a back end, the cabinet defining a chilled chamber;
a drawer slidably mounted within the chilled chamber such that the drawer is disposed within the chilled chamber when the drawer is in a closed position and is at least partially disposed outside the chilled chamber when the drawer is in an open position, the closed position and the open position being separated from each other along the transverse direction, the drawer comprising a drawer body defining an interior of the drawer and a door attached to the drawer body;
a cooling system disposed in a mechanical compartment of the refrigerator appliance, the cooling system in fluid communication with the chilled chamber to provide a flow of chilled air to the chilled chamber; and
a heating unit disposed in a stationary position within the cabinet, the heating unit proximate the drawer when the drawer is in the closed position such that the heating unit is in operative communication with the drawer when the drawer is in the closed position whereby the heating unit provides heat to the drawer within the chilled chamber when the drawer is in the closed position and the heating unit is activated.

2. The refrigerator appliance of claim 1, wherein the heating unit is an induction heating pad operable to provide heat to the drawer when the drawer is in the closed position by producing an eddy current in a cooking utensil within the drawer.

3. The refrigerator appliance of claim 1, further comprising a removable tub received within the drawer, wherein the tub provides a sous vide water bath within the drawer when the heating unit provides heat to the drawer and to the tub therein.

4. The refrigerator appliance of claim 3, further comprising a circulation pump in fluid communication with the removable tub, the circulation pump configured to circulate the water from the sous vide water bath.

5. The refrigerator appliance of claim 1, wherein the drawer is a first drawer and the chilled chamber is a first chilled chamber, further comprising a second drawer slidably mounted within a second chilled chamber.

6. The refrigerator appliance of claim 5, wherein the heating unit is a first heating unit, further comprising a second heating unit disposed in a stationary position within the cabinet, the second heating unit proximate the second drawer when the second drawer is in the closed position such that the heating unit is in operative communication with the second drawer when the second drawer is in the closed position whereby the second heating unit provides heat to the second drawer within the second chilled chamber when the second drawer is in the closed position and the heating unit is activated.

7. The refrigerator appliance of claim 5, wherein the first drawer and the second drawer are spaced apart along the vertical direction.

8. The refrigerator appliance of claim 1, further comprising a counterweight positioned within the mechanical compartment proximate the back end of the cabinet.

9. The refrigerator appliance of claim 1, wherein the drawer is the only storage component of the refrigerator appliance.

10. The refrigerator appliance of claim 1, further comprising a partition in the drawer, the partition defining a first compartment and a second compartment within the interior of the drawer.

11. The refrigerator appliance of claim 10, wherein the heating unit is a first heating unit, further comprising a second heating unit disposed in a stationary position within the cabinet, the first heating unit proximate the first compartment when the drawer is in the closed position and the second heating unit proximate the second compartment when the drawer is in the closed position.

12. A refrigerator appliance comprising:
a cabinet defining a chilled chamber;
a drawer slidably mounted within the chilled chamber such that the drawer is disposed within the chilled chamber when the drawer is in a closed position and is at least partially disposed outside the chilled chamber when the drawer is in an open position, the drawer comprising a drawer body defining an interior of the drawer and a door attached to the drawer body;
a cooling system disposed in a mechanical compartment of the refrigerator appliance, the cooling system in fluid communication with the chilled chamber to provide a flow of chilled air to the chilled chamber;
a heating unit disposed in a stationary position within the cabinet, the heating unit proximate the drawer when the drawer is in the closed position such that the heating unit is in operative communication with the drawer when the drawer is in the closed position whereby the heating unit provides heat to the drawer within the chilled chamber when the drawer is in the closed position and the heating unit is activated.

13. The refrigerator appliance of claim 12, wherein the heating unit is an induction heating pad operable to provide heat to the drawer when the drawer is in the closed position by producing an eddy current in a cooking utensil within the drawer.

14. The refrigerator appliance of claim 12, further comprising a removable tub received within the drawer, wherein the tub provides a sous vide water bath within the drawer when the heating unit provides heat to the drawer and to the tub therein.

15. The refrigerator appliance of claim 12, wherein the drawer is a first drawer and the chilled chamber is a first chilled chamber, further comprising a second drawer slidably mounted within a second chilled chamber.

16. The refrigerator appliance of claim 15, wherein the heating unit is a first heating unit, further comprising a second heating unit disposed in a stationary position within the cabinet, the second heating unit proximate the second drawer when the second drawer is in the closed position such that the heating unit is in operative communication with the second drawer when the second drawer is in the closed position whereby the second heating unit provides heat to the second drawer within the second chilled chamber when the second drawer is in the closed position and the heating unit is activated.

17. The refrigerator appliance of claim 12, further comprising a counterweight positioned within the mechanical compartment proximate the back portion of the cabinet.

18. The refrigerator appliance of claim 12, wherein the drawer is the only storage component of the refrigerator appliance.

19. The refrigerator appliance of claim 12, further comprising a partition in the drawer, the partition defining a first compartment and a second compartment within the interior of the drawer.

20. The refrigerator appliance of claim 19, wherein the heating unit is a first heating unit, further comprising a second heating unit disposed in a stationary position within the cabinet, the first heating unit proximate the first compartment when the drawer is in the closed position and the second heating unit proximate the second compartment when the drawer is in the closed position.
